(19) United States
(12) Patent Application Publication
(10) Pub. No.: US 2025/0068950 A1
(43) Pub. Date: Feb. 27, 2025

(54) FREQUENCY CONTROL AND TUNING OF MODULAR DEVICES

(71) Applicant: International Business Machines Corporation, Armonk, NY (US)

(72) Inventors: Eric Zhang, Sleepy Hollow, NY (US); Jared Barney Hertzberg, YORKTOWN HEIGHTS, NY (US)

(21) Appl. No.: 18/236,047

(22) Filed: Aug. 21, 2023

(51) Int. Cl. G06N 10/40

(52) U.S. Cl. CPC G06N 10/40

(57) ABSTRACT

Identify a plurality of candidate quantum computing chips to be arranged in a multi-chip quantum processor. Generate a current optimized tuning plan for the arrangement of the plurality of candidate quantum computing chips in the multi-chip quantum processor. Obtain results of tuning in accordance with the optimized tuning plan from at least one tuning system. Carry out tuning yield assessment based on results of the obtained tuning results. Repeat the steps of obtaining results and carrying out tuning yield assessment, based on tuning being incomplete and the current optimized tuning plan remaining viable.

### BACKGROUND

The present invention relates to the electrical, electronic and computer arts, and more specifically, to computer-aided design of quantum computing systems.

A quantum computer exploits quantum mechanics; i.e., the fact that, at small scales, matter exhibits both particles and wave properties. Quantum computers use qubits, analogous to the bit in conventional digital computing.

Qubits can be realized using many modalities. Some common modalities include superconducting qubits based on circuit quantum electrodynamics (cQED) architectures, trapped ion qubits, spin-based qubits, neutral atoms, or photonic qubits. A common modality is superconducting qubits. Superconducting qubit modalities require cooling to cryogenic temperatures, using a cryostat, a dilution refrigerator, or the like. Multi-chip quantum processors have been proposed. One pertinent example of a superconducting qubit is the fixed-frequency transmon. Quantum computers operate via quantum logic gates between qubits. Such gates may employ, for example, a microwave-activated coupling, a fast tunable coupling, or a parametric coupling between the qubits that form the gate.

A significant challenge for scaling fixed-frequency architectures is mitigating errors arising from lattice frequency collisions. The LASIQ (Laser Annealing of Stochastically Impaired Qubits) technique has been developed to increase collision-free yield of transmon lattices by selectively trimming (i.e., tuning) individual qubit frequencies via laser thermal annealing. Qubits can be addressed by using unique frequencies; however, undesirable collisions may occur, for example, when the frequencies of two nearest neighbor or next-nearest neighbor qubits become too close, or for example, when the frequency spacing between neighboring qubits are within a similar range as the qubit anharmonicity. Other variations of such frequency collisions may occur, and their precise definition will depend on the type of gates used in the quantum processor. Generally, care should be taken in the assignment of such qubit frequencies to ensure avoidance of frequency collision regions.

### SUMMARY

Principles of the invention provide techniques for frequency control and tuning of modular devices. In one aspect, an exemplary method includes the steps of identifying a plurality of candidate quantum computing chips to be arranged in a multi-chip quantum processor; generating a current optimized tuning plan for the arrangement of the plurality of candidate quantum computing chips in the multi-chip quantum processor; obtaining results of tuning in accordance with the optimized tuning plan from at least one tuning system; carrying out tuning yield assessment based on results of the obtained tuning results; and repeating the steps of obtaining results and carrying out tuning yield assessment, based on tuning being incomplete and the current optimized tuning plan remaining viable.

Optionally, the method further includes, responsive to a subsequent determination that the current optimized tuning plan no longer remains viable, generating a new optimized tuning plan and repeating, for the new optimized tuning plan, the steps of obtaining results and carrying out tuning yield assessment based on tuning being incomplete and the new optimized tuning plan remaining viable.

In another aspect, an exemplary computer program product includes a computer readable storage medium having program instructions embodied therewith. The program instructions are executable by a processor to cause the processor to perform a method including: identifying a plurality of candidate quantum computing chips to be arranged in a multi-chip quantum processor; generating a current optimized tuning plan for the arrangement of the plurality of candidate quantum computing chips in the multi-chip quantum processor; obtaining results of tuning in accordance with the optimized tuning plan from at least one tuning system; carrying out tuning yield assessment based on results of the obtained tuning results; and repeating the steps of obtaining results and carrying out tuning yield assessment, based on tuning being incomplete and the current optimized tuning plan remaining viable.

In still another aspect, a system includes a memory; and at least one processor, coupled to the memory, and operative to: identify a plurality of candidate quantum computing chips to be arranged in a multi-chip quantum processor; generate a current optimized tuning plan for the arrangement of the plurality of candidate quantum computing chips in the multi-chip quantum processor; obtain results of tuning in accordance with the optimized tuning plan from at least one tuning system; carry out tuning yield assessment based on results of the obtained tuning results; and repeat the obtaining of the results and the carrying out of the tuning yield assessment, based on tuning being incomplete and the current optimized tuning plan remaining viable.

Optionally, the results of the tuning include LASIQ (Laser Annealing of Stochastically Impaired Qubits) results. Optionally, the memory and the at least one processor are associated with a central server computer, which obtains the tuning results from multiple LASIQ (Laser Annealing of Stochastically Impaired Qubits) machines. Optionally, the system further includes one, some, or all of the multiple LASIQ (Laser Annealing of Stochastically Impaired Qubits) machines.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improves the technological process of computer-aided design of quantum computing systems, by mitigating collisions between coupled devices, both within a chip and cross-chip;
improves the technological process of computer-aided design of quantum computing systems, by selecting the appropriate devices to couple;
improves the technological process of computer-aided design of quantum computing systems, by selecting the appropriate frequencies of qubits and elements based on Josephson junctions, and the frequency tuning required of all elements in those coupled devices;
improves the technological process of computer-aided design of quantum computing systems, by resolving edge collisions across coupled devices;
improves the performance of quantum computing systems designed in accordance with exemplary embodiments, by reducing collisions as compared to prior art systems;
significant increase in yield of usable processors and modular processors. As used herein, “yield” refers to the fraction of quantum processors, of chips within a modular processor, or of qubits within the chip whose frequencies can be set so as to eliminate frequency collisions and/or to minimize gate error. The yield metric may account for frequency shifts or other random changes expected to occur subsequent to the tuning action. These may be assessed statistically using Monte Carlo models or other known methods of probability or statistical modeling. Usability in the context of quantum processors may be understood to mean benefits in terms of gate speed, gate fidelity, low collision count, or any other metric by which the quality of quantum computation may be improved;
savings of memory and/or CPU time for the computer that runs the design algorithms—one or more embodiments reduce computational complexity (and thus significantly reduces CPU and/or memory) by constraining the boundaries, or constraining both the boundaries and the internal frequencies of qubits.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a single chip that can be used in aspects of the invention;

FIG. 2 depicts an example of a modular connectivity manifold in accordance with an aspect of the invention;

FIG. 3A shows an exemplary square lattice with three modules placed, according to aspects of the invention;

FIG. 3B shows details of coupling two adjacent chips/modules, according to aspects of the invention;

FIG. 4 shows an exemplary screening and calibrating technique, according to aspects of the invention;

FIG. 5 shows an example of optimal arrangement and a method to achieve this arrangement, according to aspects of the invention;

FIG. 6 shows a linear chip build tuning plan example, according to aspects of the invention;

FIG. 7 shows a deterministic tuning plan example, according to aspects of the invention;

FIG. 8 shows an ad hoc tuning plan example, according to aspects of the invention;

FIG. 9 is an exemplary system block diagram, according to aspects of the invention;

FIG. 10 is a flow chart of tuning flow on one or multiple LASIQ systems, according to aspects of the invention;

FIG. 11 a flow chart of a method of tuning modular devices, according to aspects of the invention;

FIG. 12 depicts a computing environment according to an embodiment of the present invention; and

FIG. 13 is a high-level diagram depicting exemplary practical use of aspects of the invention.

### DETAILED DESCRIPTION

In the future, quantum processors will be assembled from multiple discrete devices with couplers. These devices may be connected to each other within a cryogenic refrigerator, or from one cryogenic refrigerator to another. One or more embodiments advantageously allow for tuning these devices in such a way as to mitigate collisions both within and between coupled devices, and/or also provide a technique to select the appropriate devices to couple during frequency tuning. One pertinent technique to perform frequency tuning of these devices is using LASIQ, which involves thermally laser annealing elements based on Josephson junctions to change the resistance of these junctions, and correspondingly, their frequency, thereby mitigating frequency collisions within a multi-qubit lattice or set of lattices. This technique is implemented in the final stages of fabrication of the qubit chip, after which the chip is installed into the modular processor and cooled in a cryostat. One or more embodiments advantageously permit resolution of edge collisions across coupled devices and/or address the case where these devices are frequency tuned on different laser annealing systems, or any other manner of frequency tuning systems. Furthermore, one or more embodiments provide a real-time optimization methodology for choosing coupled processors and/or address a situation where the arrangement of processors in the initial plan needs re-arranging. Indeed, one or more embodiments solve a multi-chip optimization problem subject to constraints of frequency tunability of individual elements on the chip. That is to say, one or more embodiments address tuning to avoid collisions both within a chip, and cross-chip with coupled devices. This latter constraint is, in general, harder to satisfy. However, one or more embodiments are implemented within a context wherein there is freedom to rearrange chip coupling configurations.

As noted above, the LASIQ (Laser Annealing of Stochastically Impaired Qubits) technique has been developed to increase collision-free yield of transmon lattices by selectively trimming (i.e., tuning) individual qubit frequencies via laser thermal annealing. However, it may be understood that embodiments described herein requiring frequency tuning are not limited solely to the use of LASIQ tuning, but rather, any frequency tuning capability of qubits and/or elements based on Josephson junctions may be utilized to satisfy the frequency tuning requirements needed to successfully implement a modular device.

Tunable superconducting qubit architectures can be employed in some instances. In one or more embodiments, significant gain in yield may be obtained using techniques to selectively trim frequencies of individual qubits and various elements based on Josephson junctions.

One or more embodiments provide a technique by which multiple chips in a single modular device are tuned on the same, or multiple, frequency-tuning systems, for example, one or multiple LASIQ tuning systems. An initial screening phase enables the selection of a set, or stack of acceptable chips to use in the modular system. The chips may be ranked or sorted by yield metrics defined by the end-user and required application. These chips are coupled on a modular system. The modular system geometry is defined by its use case. As a non-limiting example, a square tiling geometry is considered; however, this can vary in other embodiments. One or more embodiments provide techniques to tile the square modular device, using (1) a linear ranked scheme, (2) deterministic coupling, and/or (3) an ad-hoc scheme with a pre-populated lattice.

Exemplary embodiments can be applied, for example, to tuning individual chips (going in the same modular device) on a single, or multiple, LASIQ system(s). During tuning, one or more embodiments adaptively assess and optimize the yield and modify the neighbors or tuning candidates as appropriate. The global minimum solution may be solved on a single LASIQ system, or on multiple LASIQ systems tuning devices at the same time. Indeed, multiple LASIQ systems are an exemplary embodiment of tuning modular devices in accordance with aspects of the invention.

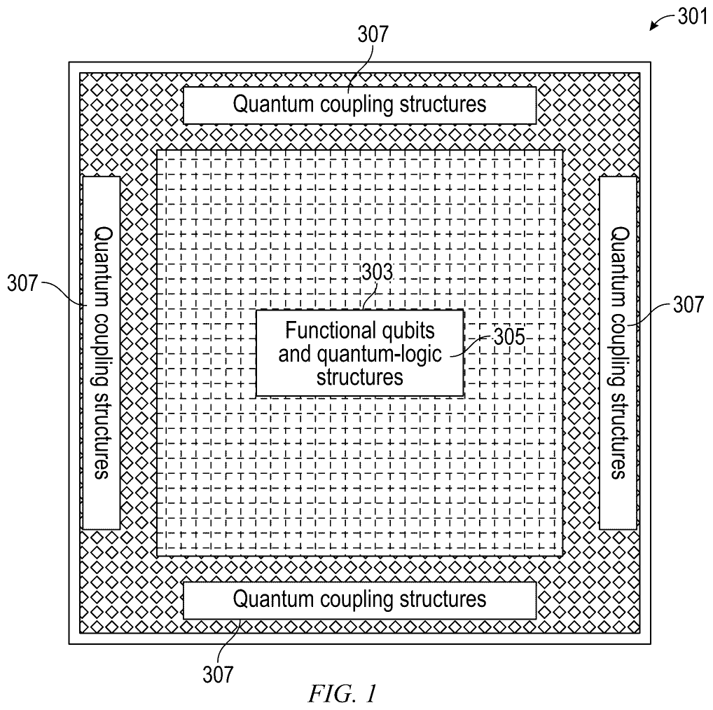

Refer now to FIG. 1, which is a schematic drawing of single chip 301 to be handled in accordance with aspects of the invention. This illustration presents a microchip which serves as one modular element in a modular quantum processing unit (QPU). Generally, each individual chip includes a set of functional qubits 303 and quantum-logic-related structures 305, and a second set of quantum coupling structures 307. Each such module will typically need to contain two distinct types of elements. The functional qubits and other quantum-logic structures store, manipulate or transfer quantum logic within the module, while the quantum coupling structures enable such actions from one module to another. In FIG. 1, the functional qubits 303 and quantum-logic structures 305 are placed in the chip interior and the quantum coupling structures 307 are placed along the chip edges; however, other arrangements may be used in practice. In one or more embodiments, all structures are made of superconducting materials on a dielectric substrate and all structures contain Josephson junctions whose tunnel-barrier is susceptible to tuning by laser-annealing. Structures may include qubits of various kinds, or SQUIDs (superconducting quantum interference devices), or single Josephson junctions, or other combinations of Josephson junctions, capacitors and inductors. They may be galvanically, inductively, or capacitively linked with neighboring structures on-chip. The functional structures may contain Josephson junctions that are of different design or construction as compared to the Josephson junctions in the quantum coupling structures. The several types of Josephson junctions typically undergo calibration to determine their response to laser-power and exposure time. These separate calibrations determine the tuning range and tuning rates specific to the functional structures and to the quantum coupling structures.

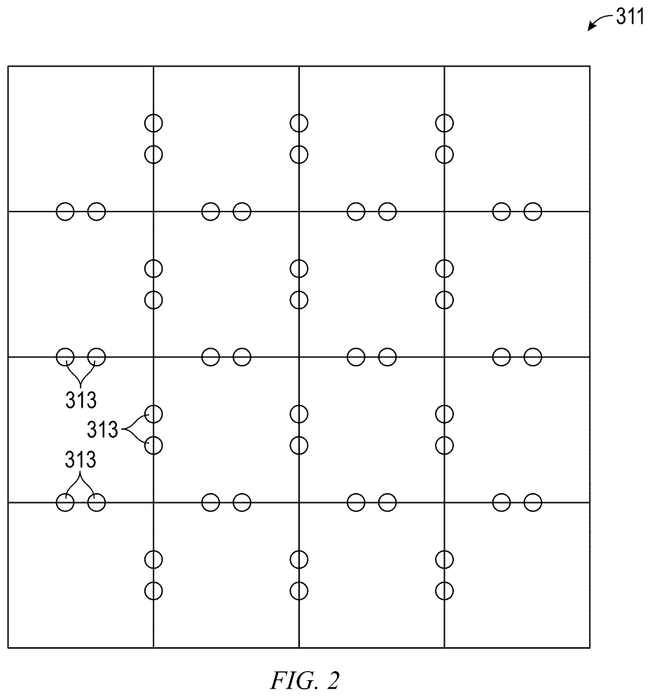

Referring now to FIG. 2, modularity is believed to be highly desirable for future scaling of quantum computers. Practically, it is prohibitively challenging to scale beyond the multi-thousand qubit range using existing superconducting qubit architectures on a single quantum chip. FIG. 2 shows a modular device manifold 311 with sixteen subcomponent (chip) locations (the sixteen square boxes, not separately numbered). One or more embodiments provide an optimal way to populate these locations on the manifold with chip candidates; i.e., techniques to select appropriate chips to install into each of the modular sites and link to the other sites in the manifold. One or more embodiments provide a heuristic optimization routine that can work in real-time, and is feasible to solve. In a non-limiting example, the chips to be coupled may make use of fixed-frequency architectures such as transmon qubits for their functional qubits and quantum logic structures 305, whose frequencies may be tuned using LASIQ and/or any other frequency tuning method. These transmon qubits may be coupled to quantum coupling structures 307 which contain Josephson junction elements and may therefore be tuned using LASIQ. In one or more other embodiments, flux-tunable architectures that involve both fixed frequency transmon qubits and tunable coupler elements may be used to form the functional qubits and quantum logic structures 305. Each of the fixed frequency transmon qubits and/or tunable coupler elements (e.g., SQUID loop) contain Josephson junctions with may also be tuned using LASIQ. In one or more other embodiments, the functional qubits and quantum logic structures 305 may contain flux-tunable qubits. It is generally to be understood that the functional qubits and quantum logic structures 305 and quantum coupling structures 307 will include at least one and possibly several types of elements including one or more Josephson junctions, as well as microwave lines and other microwave elements such as capacitors and inductors.

An example of a functional qubit is a fixed-frequency transmon or tunable transmon. An example of a functional quantum-logic structure is a quantum-logic gate element (such as a SQUID-tunable resonant coupler) engineered to link two functional qubits within the chip. An example of a quantum coupling structure is a quantum-logic gate element (such as a SQUID-tunable resonant coupler) engineered to link a functional qubit on one chip to a functional qubit on another chip.

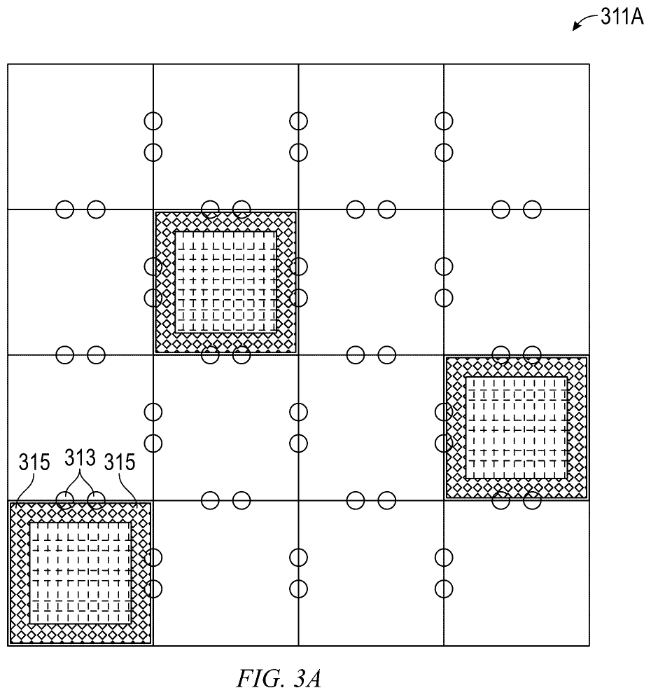

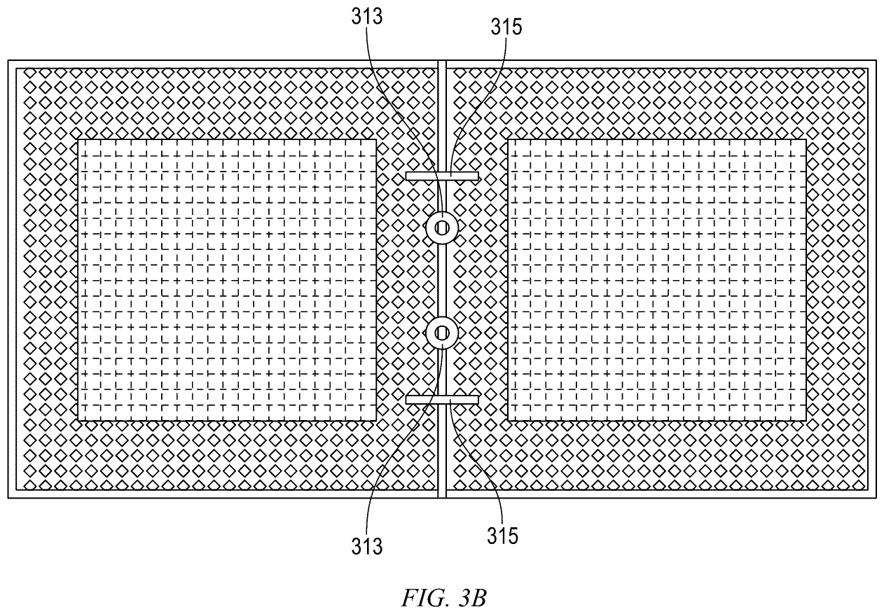

A global solution, which is computationally complex, allows arbitrary boundary conditions between chips (generally, modules). As used herein, a chip is understood to refer to a single chip as shown in FIG. 1 which includes functional qubits, quantum-logic structures and quantum coupling structures. A constrained solution, which is computationally simpler, enforces fixed boundary conditions for each chip. One or more embodiments are capable of starting from the chip level or the modularity level. When starting from the chip level, optimize individual chips by optimizing the functional qubits and quantum-logic structures, after which select candidates whose quantum coupling elements are suitable to couple into the modular system. When starting from the modularity level, start with pre-screening candidates by their coupling compatibility and then optimize their internal functional structures in a tuning plan. In FIG. 2, note that in some embodiments the links between modules will employ frequency-resonant elements fixed to the coupling manifold, so that the quantum coupling elements should have frequencies compatible with these resonant elements. For instance such links may employ microwave resonators 313. There will also be sites for direct links between quantum coupling structures 307 of the individual chips as seen in FIG. 1.; these links will be mediated by microwave lines or couplers on the coupling manifold extending across the boundary between adjacent chips, and in this case the quantum coupling elements on either side should have frequencies compatible with one another. These sites are best seen at 315 in FIGS. 3A and 3B.

Refer now to FIG. 3A, which is a schematic drawing of a square lattice of modules 311A. This lattice has positions for sixteen modules (the sixteen square boxes, not separately numbered). Each module is, in this illustration, linked to its neighbor by microwave resonators 313 fixed to the lattice and by an additional set of direct links 315 between coupling structures on neighboring modules which may be mediated by microwave lines or couplers on the coupling manifold, extending across the boundary between adjacent chips. In this lattice, three modules are already populated. The geometry of the lattice of modules (chips) will be typically defined by the type of computation, type of code, system size, and/or other considerations pertaining to engineering a useful quantum computer. Each link between chips will typically employ one quantum coupling structure on each chip, and each adjacent pair of chips in the manifold may be coupled by several such links. The region of the chip containing quantum coupling structures is 307, as seen in FIG. 1. Some links 315 may galvanically, inductively, or capacitively link the quantum coupling structure on one chip to the quantum coupling structure on the other chip. Other links may interpose an additional structure that is fixed to the lattice of modules and has a resonance frequency that must be matched by the two on-chip coupling structures. For instance, links may incorporate a superconducting microwave resonator 313, which may in one or more embodiments be tunable. A portion of the lattice of modules may be pre-populated with chips, whose functional and coupling structures are not accessible for LASIQ or other tuning techniques. Such a circumstance imposes additional constraints on a solution of compatible frequencies to fully populate the lattice. For instance, some chips may begin operating in a cryogenic refrigerator before the remaining modules are added to complete the lattice. In one or other embodiments, the manifold is within the same cryogenic refrigerator, and may, for example, include pockets for each individual chip to be placed, to couple amongst other adjacent chips. In one or more embodiments, the manifold is achieved by microwave coupling and links between cryogenic refrigerators.

Further regarding FIG. 3A, without the three chips, the structure is in essence a coupling manifold, where the boundaries between slots include microwave resonators 313 and direct links 315 (e.g., microwave line). For example, a qubit communicates with a coupling structure on the same chip; the coupling structure 315 communicates with another coupling structure on another chip either directly or via an element affixed to the lattice; and that coupling structure on the other chip communicates with a qubit on the other chip. FIG. 3B shows a detail of two adjacent coupled chips with elements 313 and 315.

Still referring to FIG. 3B, some modular processors may employ links only of type 313, others may employ only type 315, and in general processors may use a mix of the two.

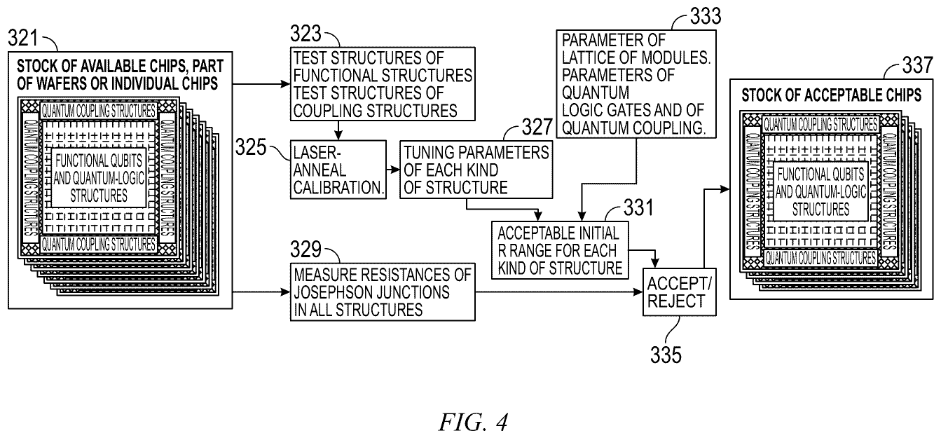

Referring now to FIG. 4, consider aspects of screening and calibrating. In one or more embodiments, before laser-tuning a set of chips to be installed as modules into a multi-chip lattice, measure the junction resistances of both functional and quantum-logic structures and quantum coupling structures on all chips, perform laser-anneal calibration for both functional and quantum coupling structures using designated test-structures, and discard chips which cannot be laser-tuned into a desired range. Designated test-structures may be specific structures on the quantum chip, or on a related sister chip that has undergone identical fabrication processing. In one or more embodiments, the sole purpose of test-structures is to undergo a trial tuning process to determine tuning parameters on the actual chip under consideration for the modular device.

Such tuning parameters include tuning range and tuning rate for functional, quantum-logic and quantum coupling structures. One pertinent reason for performing such calibration on trial junctions is to ensure high yield tuning on elements of the quantum processors. Non-limiting examples of trial junctions include on a sister chip, or trial test junctions on the actual chip (for example, trial junctions may be placed on the kerf of a chip, which is a connective region between two adjacent dies on a wafer or coupon (i.e., set of non-singulated or undiced dies)). More specifically, the tuning range may be used to estimate the annealing time and annealing power required for each junction for the actual chip being tuned, while the tuning range allows the frequencies achievable to be constrained in the tuning plan, to negate the possibility of generating a tuning plan that is impossible to obtain in practice. Under normal circumstances (nominal tuning), the junction being annealed will gradually increase in resistance, until it reaches a peak, which may, for example, be near or around 15%. However, variations in junction process methodologies will typically impact the exact value of the maximum tuning range, and it is therefore appropriate to determine this empirically. Given a set of calibration tuning curves, which may comprise a set of junctions tuned with a given anneal power and time, the maximum tuning range for a given laser power setting may be determined using an interpolation function (polynomial, logarithmic, or the like) where the maximum value may be extracted from the extrema of a curve resulting from a linear or nonlinear regression curve fitting process. In such a case, the tuning rate may be subsequently determined based on the slope of the interpolation function that is utilized. It may be assumed that junctions that have undergone the same process will have similar tuning ranges and tuning rates, which therefore enables the calibration methodology described above to remain valid.

In FIG. 4, note the stock 321 of available chips (such as 301 of FIG. 1). As will be appreciated by the skilled artisan in the field of microchip fabrication, the stock 321 of available chips may be on wafers, and screened on a wafer-scale measurement apparatus, or may be diced and handled as individual chips—microchips are typically fabricated in large batches on a wafer, and cut off of (i.e., diced from) the wafer for final assembly and packaging. One or more embodiments can be employed at wafer scale, or after chips have been removed from the wafer. In step 323, carry out tests on the functional structures such as 303 and 305 of FIG. 1, and on the coupling structures, such as 307 of FIG. 1. In step 325, carry out laser annealing calibration. In step 327, determine the tuning parameters of each type of structure, including parameters such as tuning range and tuning rate. In step 331, determine an acceptable initial resistance (R) range for each type of structure, based on the output of step 327 and the pertinent parameters 333 of the lattice of modules, the quantum logic gates, and the quantum coupling. In step 335, determine, based on the results of steps 329 and 331, whether each individual chip of stock 321 is acceptable; those that are acceptable are placed in the stock 337 of acceptable chips.

With regard to the parameters 333, such pertinent parameters represent desired frequencies or frequency ranges of qubits, functional quantum logic structures and quantum coupling structures (such as 303, 305 and 307 of FIG. 1), with frequencies determined by desired collision avoidance bounds so as to ensure high-fidelity and high-speed quantum gate operations. These desired frequency ranges will be determined by the type of qubit-qubit gate operation and the type of chip-to-chip coupling employed. As specified by these gates and couplings, the desired frequency ranges for qubits may be different from the desired frequency ranges for functional quantum logic structures and both may be different from the desired frequency ranges for quantum coupling structures. Where chip-to-chip coupling employs frequency-resonant elements 313 fixed to the coupling manifold, the desired frequency ranges of the coupling structures must be compatible with the frequencies of elements 313. Laser annealing calibration in step 325 can be carried out, for example, as known from the IBM Research Paper by Jared B. Hertzberg et. al., “Laser-annealing Josephson junctions for yielding scaled-up superconducting quantum processors,” npj Quantum Information. 2021 Aug. 19; 7(1):129.

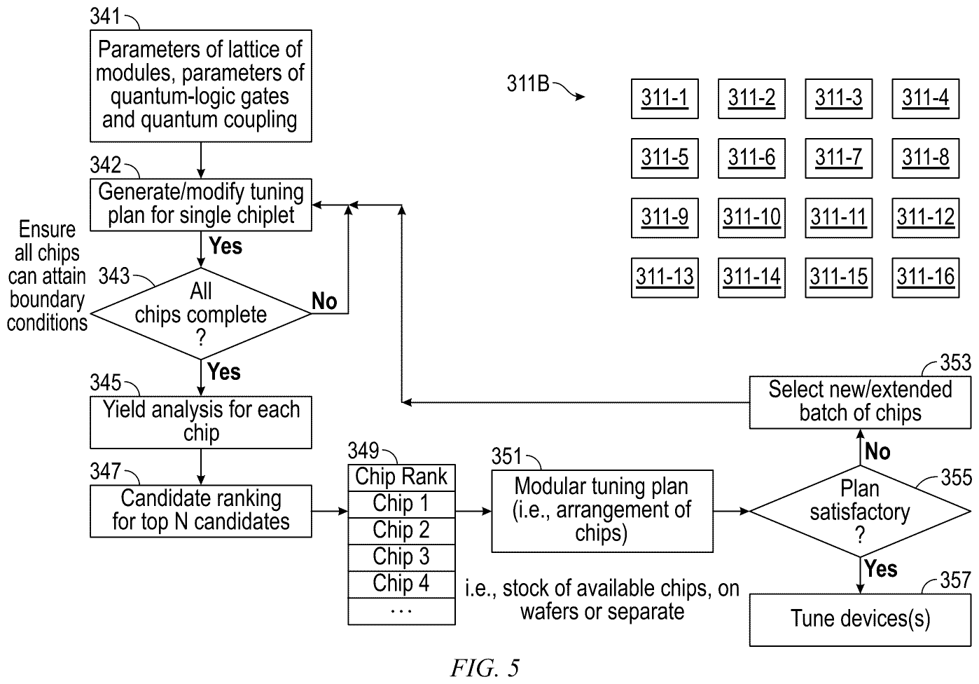

Refer now to FIG. 5. Note the modular device 311B with sixteen subcomponents (chips) 311-1, 311-2, 311-3, 311-4, 311-5, 311-6, 311-7, 311-8, 311-9, 311-10, 311-11, 311-12, 311-13, 311-14, 311-15, and 311-16. Each of sixteen subcomponents (chips) of the modular device 311B, 311-1, 311-2, 311-3, 311-4, 311-5, 311-6, 311-7, 311-8, 311-9, 311-10, 311-11, 311-12, 311-13, 311-14, 311-15, and 311-16 are internally optimized, but their optimized plans may be in conflict with global plans. It is desired to determine the optimal arrangement to avoid collisions. One or more embodiments select appropriate chips to face each other. There are 16!=16×15×14 . . . =2.1×10¹³ ways to arrange this (and even more, given that the sixteen chips are chosen from a larger set of chips as indicated by stock 321 of FIG. 4). One or more embodiments provide a heuristic optimization routine that can work in real-time, and is feasible to solve. In this example, the modular quantum processor includes sixteen module sites arranged in a square array, such that each chip links to at least two and no more than four other chips within the processor. In general, the design of the array could take a variety of other forms and geometries, not limited to a square geometry and not limited to this number of neighboring chips.

In step 341, parameters of the lattice of the intended modular device, and parameters of the quantum logic gates and quantum coupling structures are used as inputs to step 342, where a tuning plan is generated for a single chip, or an existing tuning plan for a single chip is modified, as the case may be (discussed further below). This ensures that all chips can attain the required boundary conditions. In decision block 343, determine whether tuning plans for all chips from the stock of available chips are complete; if not, logical flow proceeds back to step 342; if yes, proceed to step 345. In step 345, carry out yield analysis for each individual chip. In step 347, use the resulting yield analysis to carry out candidate ranking for the top N candidates to obtain a chip ranking 349. In one or more embodiments, rank the entire stock of available chips, which may be on wafers, and screened on a wafer-scale measurement apparatus, or may be diced and handled as individual chips. In step 351, having ranked the chips based on the individual tuning plans, implement a modular tuning plan to determine a suitable arrangement of chips. In decision block 355, determine whether the plan developed in step 351 is satisfactory, which in one or more embodiments is determined by the number of total frequency collisions in the modular device configuration, or in one or more embodiments is determined by the gate fidelity in the modular device. If the plan developed in step 351 is satisfactory, follow the YES branch to step 357 and tune the devices accordingly. On the other hand, if the plan is not satisfactory, follow the NO branch to step 353 and select a new or extended batch of chips. Logical flow then proceeds to step 342. With further regard to step 342 and the language “generate/modify,” during the first iteration of step 342 and decision block 343, a tuning plan will typically be generated for each chip. On the other hand, during subsequent loops of step 342 and decision block 343, reached from step 353, chips already in the batch can have a modified tuning plan while newly added chips have an initial tuning plan generated.

Still referring to FIG. 5, in the non-limiting example, there are sixteen devices 311-1 . . . 311-16 that are desired to be coupled together. Depending on the exact configuration and how it is desired to couple the devices, it is desired to mitigate collisions and maximize gate fidelities within each one of the chips 311-1 . . . 311-16, and to mitigate collisions at the coupling edges, where the chips communicate with other adjacent chips. In this non-limiting example, communication between adjacent chips may be understood to mean the transfer of qubit information, the entanglement of qubits, and/or generally the operation of a multi-qubit gate across the boundary between adjacent chips. Thus, there are edge constraints and inside constraints. An optimal configuration for chip 311-1 and an optimal configuration for chip 311-2 will, in general, not be the same as an optimal configuration for the two chips 311-1, 311-2 when they are coupled together. In one or more embodiments, the tuning plans are modified in real-time and on the fly. In one or more embodiments, as at step 342, start by generating a tuning plan for a single chip based on parameters defined in step 341, cycling through all sixteen chips. In one or more embodiments, implement a global tuning plan (global arrangement of chips) in step 351 and determine, in decision block 355, whether the plan is satisfactory. The plan may be deemed satisfactory or not based on yield metrics, including, but not limited to Monte Carlo modeling of collision and zero-collision yield, or gate error modeling based on a specific use case, or optimization and/or heuristics as defined by the quantum architecture. One or more embodiments of gate error modeling may include gate error modeling derived from cross-resonance interaction of fixed-frequency transmon qubits. If the plan in decision block 355 is acceptable (YES branch), tune the devices per the plan in step 357. Note, the skilled artisan will appreciate that generally, high collisions are correlated with high gate error, or low gate fidelity.

In one or more embodiments, enforce a boundary condition (BC) on each chip so it can mate with a chip of a certain frequency pattern next to it, and then it is not necessary to coordinate between the different chips; rather, just seek to hit those targets. One or more embodiments can use a simple algorithm (enforcing BC) or a more complex algorithm, such as dynamical rearrangement. In some instances, if tuning is initiated and it is determined that one chip is significantly out of specification, there is still time to change the BC on the other chip as well. Further regarding BC, in some instances, a modular system can be developed where multiple chips can be mated in the same slot of the larger modular system. For example, if a chip is connected and it malfunctions, there is a way to remove it and add a new chip in its place. In that case, simply comply with a fixed BC plan, so that, in the future, a new device can be tuned and swapped with a malfunctioning device. There will typically be some tuning strategy employed regardless of the architecture.

Again, in one or more embodiments, a starting point 341 is to determine the parameters based on the specific tuning methodology of the embodiment (for example, enforcing BC), followed by a step 342 to generate/modify a tuning plan for a single chip, eventually tuning all the chips as per the loop defined by decision block 343. In one or more embodiments, it is appropriate to have a plan to understand the intersections between the modules, as merely tuning the modules individually without regard for their interactions at the boundaries between adjacent chips would typically not be suitable.

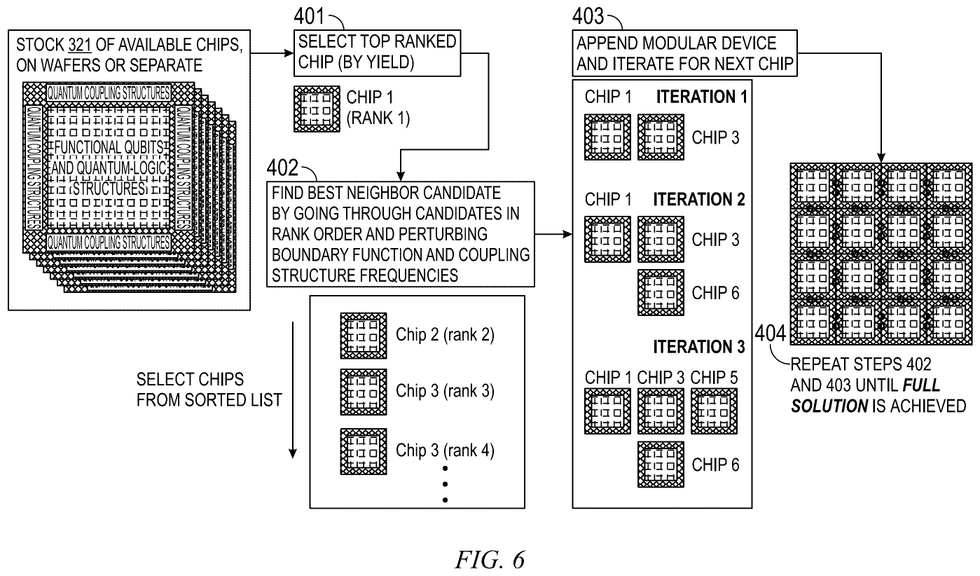

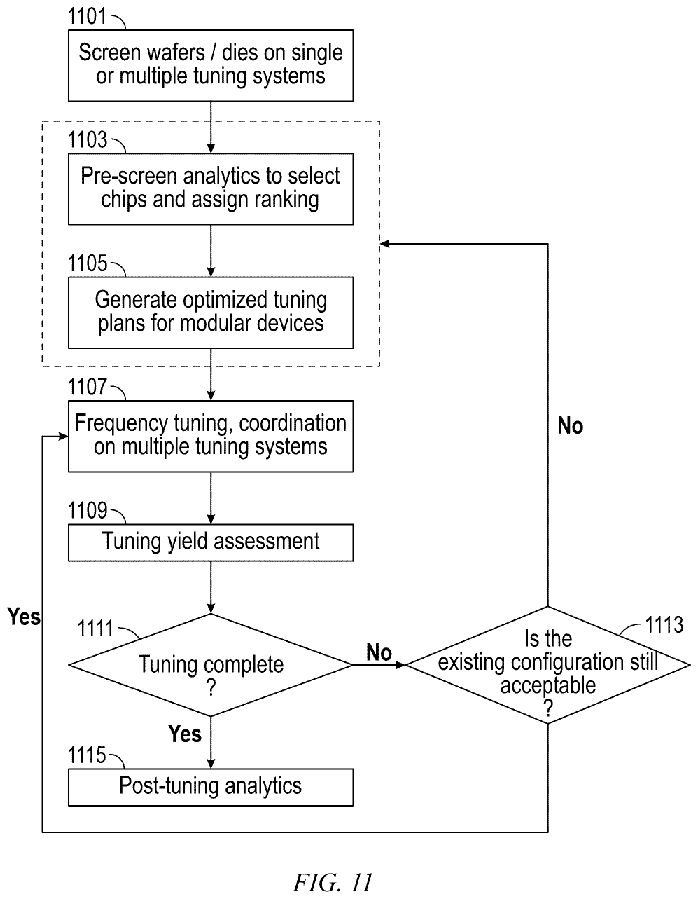

Referring now to FIG. 6, discussed in greater detail below, in one or more embodiments, a pertinent aspect is to screen the available chips. Refer also to the discussion of FIG. 11 elsewhere herein. With continued reference to FIG. 5, in one or more embodiments, powerful software is employed to pick the best arrangement of 311B. This is equivalent to “generate optimized tuning plans for modular devices,” corresponding to 1105 in FIG. 11, discussed in greater detail herein. FIGS. 6-8, discussed in greater detail below, present various exemplary aspects of tuning plans.

FIG. 6 shows a first tuning plan example, for a linear chip build. In step 401, select, from the stock 321, the top ranked chip by yield (e.g., Chip 1 (rank 1)). In step 402, find the best neighbor candidate by going through the candidates in rank order (selecting the chips from the sorted list, as indicated) and perturbing boundary function and coupling structure frequencies. The results of three iterations are shown to the right of step 402. In step 403, append the modular device identified in the most recent iteration. As seen at 404, this process is repeated until a full solution is achieved (in the example, until all 16 available spaces are populated). Using this linear build for the modular device, at each stage, the best possible candidate is selected to couple into the existing structure until finally, the full modular device is completed.

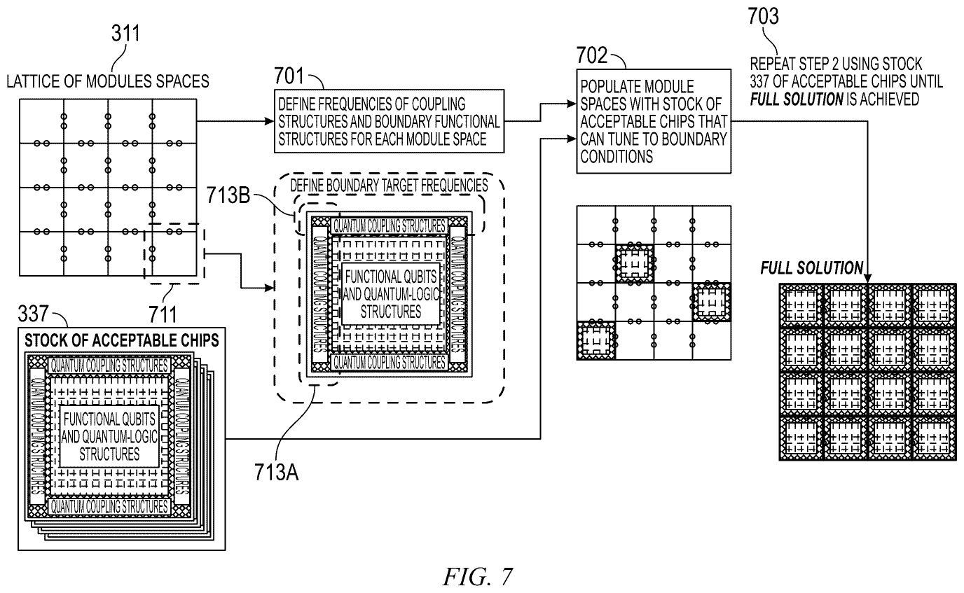

FIG. 7 shows a second tuning plan example, for deterministic tuning. In step 701, define the frequencies of the coupling structures and boundary functional structures for each module space in the lattice 311. “Boundary functional structures” refers to the functional quantum-logic structures or functional qubits on a chip that link directly to the quantum coupling structures on that chip. For example, outline 711 refers to location 311-16 and, as can be seen in the enlarged view, the boundary target frequencies are defined for the outlined regions 713A and 713B that will border other modules. In step 702, based on the output of step 701 and the stock 337 of acceptable chips, populate the module spaces with the stock of acceptable chips that can tune to the boundary conditions. As shown at 703, step 702 is repeated using the stock 337 of acceptable chips until a full solution is achieved (in the example, until all 16 available spaces are populated). In the case where the existing stock of chips cannot satisfy all the boundary conditions for all module spaces, a new set of chips may be screened and ranked, as described previously by step 353 in FIG. 5. In one or more embodiments, the frequencies of internal functional qubits and quantum logic structures are individually optimized on a chip-by-chip basis, while satisfying the necessary fixed boundary conditions. In other embodiments, the internal frequencies of functional qubits and quantum logic structures may be tuned to fixed-frequency patterns, while satisfying the necessary fixed boundary conditions. By way of clarification, FIG. 7 depicts deterministic tuning with fixed BC. For example, the coupling manifold is empty and the coupling structures have fixed frequencies. In some embodiments using FIG. 7 techniques, chips are optimized internally and are selected to comply with the BC, reducing computational complexity. In other embodiments using FIG. 7 techniques, a fixed frequency pattern is imposed on the qubits and functional quantum-logic structures. Chips satisfying this requirement are then selected to comply with the BC, still further reducing computational complexity.

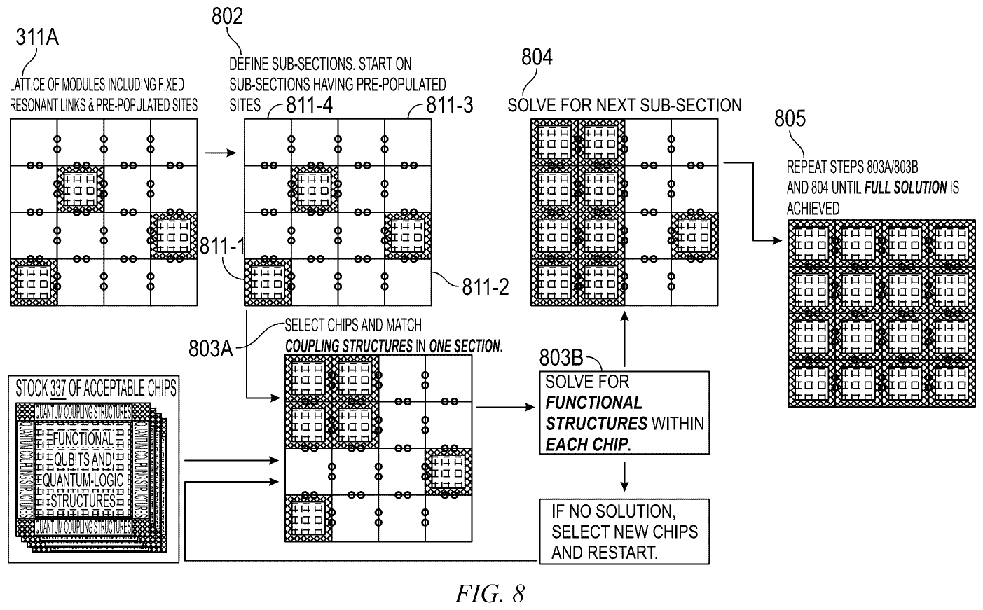

FIG. 8 shows a third tuning plan example, using ad hoc plans for both the individual chips and global modular device. In step 802, define subsections 811-1, 811-2, 811-3, and 811-4 in the lattice 311A of modules, which may include fixed resonant links and may or may not contain pre-populated modules. More specifically, 311A shows a modular manifold in which three sites have been pre-populated. In one or more embodiments, where pre-populated sites exist, start on sub-sections having pre-populated sites; i.e., start on one of 811-1, 811-2, or 811-4. In the example, as seen in step 803A, start on sub-section 811-4-select chips and match the coupling structures in one sub-section. In step 803B, solve for functional qubits and quantum-logic structures (i.e., ‘functional structures’ in 803B) within each chip. If successful, in step 804, proceed to the next subsection (in the example, 811-1). Otherwise, if no solution is found in step 803B, select new chips from the stock 337 and restart. If no solution is found after using the entire stock 337 of usable chips, a new set of chips may be screened and ranked, as described previously by step 353 in FIG. 5. As seen at 805, steps 803A/803B and 804 are repeated until a full solution is achieved (in the example, until all 16 available spaces are populated). In one or more embodiments, the sub-sections may be divided based on the discretion of the end-user. For example, the full modular manifold may be divided into only two equal sub-sections (each including eight sites), or any other division of sub-sections that the end-user may deem appropriate. In one or more embodiments, the boundary conditions may be perturbed to mitigate residual collisions between lattice sub-sections, to mitigate total collisions in the completed modular device.

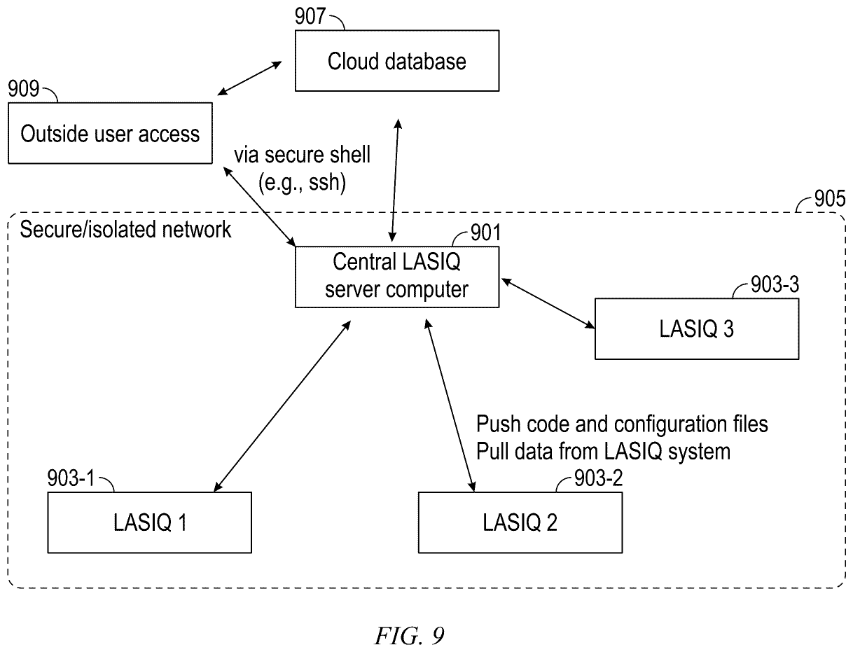

Refer now to FIG. 9 and consider tuning modular devices on multiple LASIQ systems (i.e., coordination on multiple systems). It is to be understood that any system that enables frequency tuning of functional qubits or quantum-logic structures, coupling structures, or any element consisting of one or more Josephson junctions may be used to replace the individual LASIQ systems. In one or more embodiments, each individual integrated LASIQ system can be synchronized by the use of a central server—the data is synchronized and coordinated for tuning modular devices, such as devices that go into a single modular processor. For example, International Business Machines Corporation plans to introduce “Kookaburra,” which will be a 4158 qubit multi-chip processor (i.e., modular device) with quantum communication links between the chips of the modular device. The planned Kookaburra device will be formed by a 3×3 modular manifold, which will fit a total of 9 individual chips. Such a multi-chip modular device is a non-limiting example of a processor that could be tuned on different LASIQ systems using techniques disclosed herein. The central LASIQ computer 901 pushes code and LASIQ system configuration files to each individual LASIQ system 903-1, 903-2, 903-3, which ensures that each system is appropriately configured and calibrated to tune chips. The central LASIQ computer 901 also coordinates data aggregation (pulling data from each LASIQ system). In one or more embodiments, communication to each LASIQ system 903-1, 903-2, 903-3 can only occur through the central LASIQ computer 901, and elements 901, 903-1, 903-2, 903-3 are located within a secure/isolated network 905, with a level of security or isolation determined by the needs of the end-user. Central LASIQ computer 901 also communicates with cloud database 907, and, as indicated at 909, an outside user can access via the cloud database 907 or using a secure shell (e.g., Secure Shell Protocol (SSH)) to access computer 901, or any other form of communication protocol deemed suitable by the end-user. Cloud database 907 is configured to, inter alia, store data used by LASIQ central computer 901 to manage laser annealing operations performed by LASIQ systems 903-1, 903-2, 903-3. By way of example only, cloud database 907 can store codebase versions and tuning parameters to send (e.g., push) LASIQ systems 903-1, 903-2, 903-3, and measurement data and other metrics obtained (e.g., pulled) from LASIQ systems. LASIQ central computer 901 can synchronize the laser annealing operations across LASIQ systems. In some embodiments, cloud database 907 can be implemented as a public cloud, a private cloud, or a combination thereof. In some embodiments, cloud database 907 can be co-located with LASIQ central computer 901.

Still referring to FIG. 9, in one or more embodiments, central LASIQ server computer 901 is a powerful machine that has sufficient computational capacity to run, for example, massively parallel implementations of Monte Carlo methods to assess the yield of individual chips as well as modular devices. Server 901 communicates with multiple LASIQ systems 903-1, 903-2, 903-3. Server 901 can have a large number (e.g., 64) of processing cores and can be capable of real-time pushing of code and configuration files to the dynamic, hierarchical cloud database 907 and the multiple LASIQ systems 903-1, 903-2, 903-3, and of real-time visualization of tuning progression and yield analysis. Referring to 909, an outside user can communicate with the central LASIQ server via SSH or the like and also pull data from the database 907. In one or more embodiments, central LASIQ server 901 carries out the continual yield assessment and pushes new tuning plans to the multiple LASIQ systems 903-1, 903-2, 903-3 as needed.

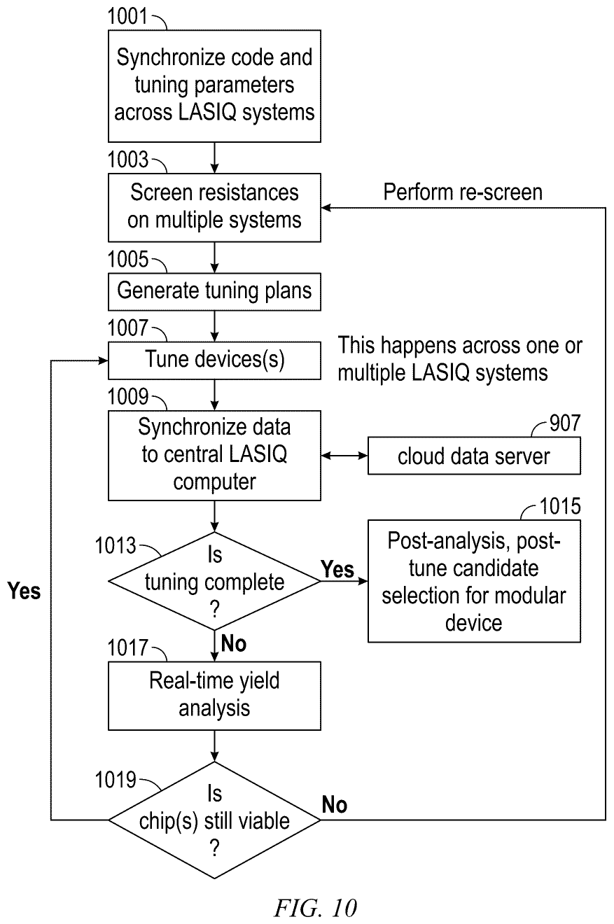

Referring now to FIG. 10, consider tuning flow on one or multiple LASIQ systems. One or more embodiments provide asynchronous flow for real-time changes/correction to tuning plans and/or real-time tuning feedback for modular systems. By asynchronous flow, it is meant that one or more LASIQ systems are operating simultaneously to tune individual chips that may become part of the resulting modular device, and that the tuning may or may not follow a specific ordering of chips. An equivalent meaning of asynchronous flow in this context may be understood to refer to parallelized tuning of multiple chips that will be part of the same modular device. After each tuning round of all the chips, the resulting progression of the overall modular device may be assessed. In one or more embodiments, a central LASIQ computer (901 in FIG. 9) is responsible for coordinating data arising from the tuning progression in each LASIQ system, and to order the data in a dynamic and hierarchical database, or the like. The individual chips on each LASIQ system may be a diced and/or individual chip candidate, or may be part of a wafer that is yet to be diced and/or separated into individual chips. The network is pertinent for tuning modular devices in one or more embodiments, since multiple devices that will eventually be connected may or may not be tuned on the same LASIQ system. In step 1001, synchronize the code and tuning parameters across the LASIQ systems. In step 1003, screen the resistances of a set of chips on multiple systems. In step 1005, generate tuning plans for the modular device and the individual chips. In step 1007, tune the device(s) across one, or multiple, LASIQ systems. In step 1009, synchronize the data to the central LASIQ computer 901, which communicates with cloud data server 907 as discussed above. In decision block 1013, determine whether tuning is complete. If so, proceed to step 1015 and carry out post-analysis and post-tune candidate selection for the intended modular device or devices. If not (NO branch), carry out real-time yield analysis in step 1017. Then, in decision block 1019, determine whether the chip(s) is/are still viable. If so, logical flow proceeds back to step 1007. Otherwise (NO branch), proceed to step 1003 and re-screen. This re-screen process is identical in nature to step 353 in FIG. 5. Where the tuning flow in FIG. 5 is intended to be generally applicable to tuning a modular device, FIG. 10 as described above elaborates on the specifics of tuning using one or more LASIQ systems to asynchronously tune multiple chips intended to be part of one or more modular devices.

Referring now to FIG. 11, consider additional aspects of tuning flow on one or multiple LASIQ systems. This flow incorporates one embodiment of a full tuning scheme on multiple LASIQ systems for modular devices that incorporates feedback. In step 1101, screen wafers/dies on single or multiple LASIQ systems. In step 1103, carry out pre-screening analytics to select chips. In step 1105, generate optimized tuning plans for modular devices. In step 1107, carry out LASIQ tuning and coordination on multiple LASIQ systems. In step 1109, carry out tuning yield assessment. In decision block 1111, determine whether tuning is complete. If so, carry out post-LASIQ analytics in step 1115; else (NO branch) proceed to decision block 1113. In decision block 1113, determine whether the existing configuration is still acceptable. If so, logical flow proceeds to step 1107; otherwise (NO branch), proceed back to steps 1103 and 1105.

Step 1105 can be carried out, for example, using any of the techniques described with regard to FIGS. 6-8. One or more embodiments utilize a ranking scheme for chip candidates and ordering (see FIG. 4); refer to step 1103. With regard to step 1105, details of the complexity of modularity and how to optimize for same are discussed with regard to FIGS. 1 and 2.

Each overall loop in FIG. 11 is thus the equivalent of one annealing round of tuning across all the chips of the entire modular device. In one or more embodiments, in real time, determine how well the tuning is progressing in step 1109. This can be done, for example, using predictive analysis to look for overshoots and/or undershoots of junction resistance, or equivalently, the frequencies of functional qubits, quantum-logic structures, and/or quantum coupling structures. Another form of predictive analysis is to calculate the number of collisions that will be obtained both within and across each chip in the modular device, and the estimated collisions free yield. This may be accomplished, for example, using a Monte Carlo method by which the predicted frequencies undergo a random scatter around some precision interval. A statistical analysis of the resulting likelihood of collision yield may be performed using such a statistical methodology, or the like. Another form of predictive analysis can employ a model of quantum gate operation which takes qubit frequencies as a variable and predicts the error for all quantum logic gates within each chip and/or within the entire modular QPU. Another form of analysis can seek to predict a performance metric, such as Quantum Volume, for each chip or for the entire modular QPU. If tuning is not complete (NO branch of block 1111), check in decision block 1113 to see if the tuning configuration is reasonably approaching an optimal configuration (as defined by the tuning plans in FIG. 6-8). If not optimal, or the current tuning configuration is outside the bounds of what is acceptable, go back (NO branch of block 1113) to steps 1103 and 1105 and (re)generate tuning plans based on existing constraints of how far each individual element on the chip(s) can tune/have tuned. For example, an element containing a Josephson junction may be tuned partially to target, but given a new tuning plan, it is typically necessary to account for the existing tuning that has already been performed on each element on the chip(s). Additionally, tuning plans are (re)generated given the above constraints for each structure, as well as how the individual chips are coupled together in the modular device (i.e., essentially, revisiting the optimal solution as tuning is carried out, by using knowledge of existing tuning progression, and revisiting how the modules should be coupled together). If still optimal, follow the YES branch of block 1113 back to the LASIQ tuning step 1107 as part of a recurring checking process, coordinated across multiple LASIQ systems.

An annealing round, in the context of tuning a modular quantum device across multiple systems, refers to a single round of tuning across all chips intended as part of the modular device. This annealing is asynchronous in the sense that not every processor tunes at the same rate. To allow coordination, the data is aggregated in a database, as shown as 907 in FIGS. 9 and 10, which may be dynamic and hierarchical to allow identification of each junction (e.g., as part of a evaporation, chip, lot, wafer, fabrication process details, etc.), as well as reconstruction of its entire tuning history to allow in-situ and real-time modifications of associated tuning plans on the chip, using the feedback based on yield metrics as shown in the exemplary FIGS. 10 and 11. In other embodiments, the respective LASIQ system will proceed with tuning in such a manner as to ensure that each chip in the modular device completes its anneal round on its respective LASIQ system prior to commencing the next round, using an appropriate time delay as desired, to force synchronous tuning across the entire modular device using a plurality of LASIQ systems.

Each chip of a modular device may, in general, be tuned on its respective LASIQ system (i.e., not the same system), and each chip may be tuned in a ‘round-robin’ format. This is a tuning process in which all qubits on a multi-qubit device undergo the laser annealing process in succession, and which may be followed by another round-robin or multiple round-robins in succession. Such round-robins may be continuously performed until all qubits on the multi-qubit device reach their respective targets. For example, a singulated quantum chip may include a number of qubit devices (e.g., 100 qubits, denoted Q1, Q2, Q3, . . . , Q100) including Josephson junctions. In an exemplary embodiment of a tuning method, Q1 will first be tuned with one or more annealing iterations, as desired. The process will proceed to Q2, where one or more annealing iterations may be performed, as desired. The process will then proceed to Q3, etc. until finally Q100 is tuned with one or more annealing iterations, as desired. This entire process from Q1 to Q100 is defined as one round-robin. After this first round-robin, the process may return to Q1, and will repeat again until Q100 is reached. The process of successive round-robins may provide time control and delay between iterations or sets of iterations, such that the Josephson junctions may be permitted to relax to their final resistances prior to the next annealing iteration or set of iterations.

The term “annealing iteration” used herein and in the specific context of a laser annealing process is meant to refer to the process which comprises a single laser pulse along with associated control, measurement and computation by the LASIQ computer system and apparatus to determine the necessary anneal time and power for the anneal pulse. A laser annealing iteration, or LASIQ iteration, therefore, refers to the entire process by which a Josephson junction is measured, the anneal power and time is determined, and the anneal pulse is performed. In this sense, one iteration involves the entire sequence of the laser annealing system and apparatus as it pertains to one step of the progressive approach to the resistance target for one Josephson junction. The tuning of one junction to completion (i.e., reaching its resistance target) may therefore be said to progress “iteratively.” The term “annealing iterations” as used herein, therefore refers generally to a set of iterations, as applicable to one or more qubit devices, or the like, including Josephson junctions, whereby the one or more qubit devices (or other elements including Josephson junctions) are tuned in multiple steps with the purpose of approaching their respective targets.

The embodiment outlined in FIG. 11 may be understood to generalize upon the specific methodology given in FIGS. 9 and 10, whereby any system or coordination of frequency tuning systems using which the frequency of functional qubits, quantum-logic structures, quantum coupling structures, or any element containing Josephson junctions may be frequency tuned. The ranking scheme and optimized plan generation process is a generalized combination of the screening as shown in FIG. 4 and steps 341-355 in FIG. 5. Additionally, frequency tuning and coordination of one or more frequency tuning systems may be accomplished in a synchronous or asynchronous fashion in step 1107, as described above, and also employing the techniques of FIGS. 6-8, as will be appreciated by the skilled artisan.

One or more embodiments make use of a ranking technique to rank order chip configurations, and also the best chips, across multiple LASIQ systems. One or more embodiments essentially solve an optimization problem, optimizing the external configuration based on the constraints of each individual chip.

It will be appreciated that the optimal placement (for example, as in view 311B) can be computationally intensive—one thousand qubits on a single device may be easier than arranging ten one hundred qubit devices. However, some configurations can be eliminated because the BC are non-resolvable. Therefore, the methods outlined in FIG. 6-8 represent optimization heuristics that reduce a computationally intractable problem to a solvable system in reasonable time.

It will thus be appreciated that one or more embodiments provide techniques to laser tune a modular quantum system based on modular device boundary conditions. One or more embodiments further include techniques to rank a series of individual quantum chips and/or techniques to tune using a linear chip build scheme, where the modular system build starts with the highest ranked chip and follows by finding the optimum connected chip by proceeding through candidates in rank order. Some embodiments provide techniques to tune using a deterministic process. Some embodiments provide techniques to tune using ad hoc plans with or without pre-populated sites on an existing modular device. Some embodiments provide techniques for laser tuning of a modular device using a single or multiple LASIQ systems. In some instances, tuning of a modular device using multiple LASIQ systems is coordinated through a central LASIQ computer which coordinate all data from multiple LASIQ systems. In some embodiments, the central LASIQ computer may be in communication with a cloud database 907, which is configured to, inter alia, store data used by LASIQ central computer 901 to manage laser annealing operations performed by multiple LASIQ systems. In some embodiments, cloud database 907 can be co-located with LASIQ central computer 901.

### Recapitulation

Given the discussion thus far, it will be appreciated that, in general terms, an exemplary method, according to an aspect of the invention, includes the step (e.g., 1103) of identifying a plurality of candidate quantum computing chips to be arranged in a multi-chip quantum processor (for example, using techniques of FIG. 4). A further step (e.g., 1105) includes generating a current optimized tuning plan for the arrangement of the plurality of candidate quantum computing chips in the multi-chip quantum processor (for example, using techniques of FIGS. 6-8). For the avoidance of doubt, in the phrase “a current optimized tuning plan,” the word “current” is used in the sense of occurring in or existing at the present time, or most recent, as opposed to necessarily pertaining to electrical current. Further steps include (e.g., 1107) obtaining results of tuning in accordance with the optimized tuning plan from at least one tuning system; (e.g., 1109) carrying out tuning yield assessment based on results of the obtained tuning results; and repeating the steps of obtaining results and carrying out tuning yield assessment based on tuning being incomplete and the current optimized tuning plan remaining viable (e.g., while/responsive to decision block 1111 yields a “NO” and decision block 1113 yields a “YES”).

Generally, it is desired to determine the optimal arrangement of chips; one or more embodiments select appropriate chips for each site in the processor.

As an aside, it is worth noting that generally, yield can be divided into at least two principal elements. The first is tuning yield, which is a measure of the precision and/or accuracy of laser tuning of the Josephson junctions. The second is functional yield, which is a measure of the number of collisions of the tuned multi-qubit lattice, zero-collision probability, gate error yield (i.e., average gate error and gate fidelity), and the like. In general, the process of screening (as in FIG. 4 and steps 341-355 of FIG. 5), which involves determining whether a candidate is acceptable for tuning, by or in part from generating a tuning plan and assessing the quality of the tuning plan, relies on the assumption of perfect tuning yield. That is, all qubits successfully attain their targets after laser annealing. However, imperfect tuning yield will impact functional yield in the sense that qubits are no longer able to attain their target frequencies in all cases, which may impact the assessment of collisions, zero-collision probability, gate errors and the like. In this context, tuning yield is most suitably assessed in the context of its impact on functional yield. Other types of yield that may be impacted can also be considered; e.g., longest high gate fidelity chain that can be constructed, or likelihood of achieving a metric for processor performance, such as a desired Quantum Volume. Such yield metrics may express the probability that a processor will achieve such targets after full tuning, population of modules, and cooling in a cryostat; or such yield may express the fraction of available modules that are deemed suitable for tuning and installation into the processor; or such yield may express the fraction of qubits, coupling structures or qubit-to-qubit quantum logic gates that perform with low error or without frequency collisions. Yield may in some embodiments be estimated with regard to additional random scatter expected to occur in the resonance frequencies of qubits or other structures, subsequent to laser-anneal tuning and installation of modules. The effect of such random scatter on gate error or other metrics may be estimated using statistical modeling methods.

One or more embodiments further include, responsive to a subsequent determination that the current optimized tuning plan no longer remains viable, generating a new optimized tuning plan and repeating, for the new optimized tuning plan, the steps of obtaining results and carrying out tuning yield assessment based on tuning being incomplete and the new optimized tuning plan remaining viable (e.g., while/responsive to decision block 1111 yields a NO and decision block 1113 also yields a NO).

In some instances, responsive to a subsequent determination that tuning is complete (YES branch of block 1111), carry out post-tuning analytics at 1115.

In one or more embodiments, in the obtaining step, the results of the tuning include LASIQ (Laser Annealing of Stochastically Impaired Qubits) results. As noted, however, other tuning techniques can also be employed in addition to or instead of LASIQ. In at least some embodiments employing LASIQ, the results of the tuning are obtained at a central server computer 901 from multiple LASIQ (Laser Annealing of Stochastically Impaired Qubits) machines 903-1, 903-2, 903-3, . . . . Such tools generally include a laser, tool holder, numerical controller, and the like, as will be familiar to the skilled artisan; that is to say, each LASIQ machine typically includes a local tuning system and associated control computer.

Referring to step 1103 and FIG. 4, in some instances, identifying the plurality of candidate quantum computing chips to be arranged in the multi-chip quantum processor includes accessing a stock 321 of available quantum computing chips; at 323, testing functional and coupling structures of each of the available quantum computing chips; at 325, carrying out laser annealing calibration based on results of the testing; and at 327, determining a tuning range of each of the functional and coupling structures. Further, at 335, based on results of the determining of the tuning range and parameters of the stock of available quantum computing chips, determine an acceptable initial resistance range for each of the functional and coupling structures; and, based on results of determining the acceptable initial resistance range and junction resistances of the stock of available quantum computing chips, accept a first fraction of the available quantum computing chips as the plurality of candidate quantum computing chips to be arranged in the multi-chip quantum processor and reject a second fraction of the available quantum computing chips. Note that functional structures can include, for example, functional qubits and quantum logic structures.

Referring to FIG. 6, in some cases, generating the current optimized tuning plan for the arrangement of the plurality of candidate quantum computing chips in the multi-chip quantum processor includes applying a linear chip build approach. For example, access a stock 321 of available quantum computing chips; at 401, select, from the stock, a top ranked chip by estimated functional yield (e.g., of qubits and other quantum logic structures on that chip which can be tuned to favorable frequencies for the purpose of avoiding frequency collisions and achieving low quantum gate errors); at 402, find, from the stock, a best neighbor candidate for the top ranked chip by yield, based on frequency perturbation of the coupling structures (e.g., quantum coupling structures; generally, can include coupling structures which couple to fixed resonant links within the processor and/or those which form links directly between chips); and, at 404, repeat the steps of selecting and finding until a full solution is achieved.

Referring to FIG. 7, in some cases, generating the current optimized tuning plan for the arrangement of the plurality of candidate quantum computing chips in the multi-chip quantum processor includes applying deterministic tuning. For example, access a specification 311 of potential locations for the plurality of candidate quantum computing chips to be arranged in the multi-chip quantum processor; at 701, define, based on the specification, frequencies of coupling structures and boundary functional structures for each potential location (for example, a portion of the coupling structures couple to fixed resonant links within the processor and another portion of coupling structures form links directly between chips); at 702, populate, from a stock 337 of acceptable quantum computing chips, the potential locations with ones of the acceptable quantum computing chips capable of tuning to the defined frequencies of coupling structures and boundary functional structures; and, at 703, repeat the populating step until a full solution is achieved.

Referring to FIG. 8, in some cases, generating the current optimized tuning plan for the arrangement of the plurality of candidate quantum computing chips in the multi-chip quantum processor includes applying an ad hoc, subsection-based approach. For example, access a specification 311A of potential locations for the plurality of candidate quantum computing chips to be arranged in the multi-chip quantum processor, wherein the specification includes fixed resonant links and is partially pre-populated. At 802, define subsections within the specification, beginning on ones of the subsection corresponding to the partial pre-population; at 803A, select, from a stock 337 of acceptable quantum computing chips, one or more of the acceptable chips and match coupling structures in a given one of the subsections until a solution is obtained (see 803B); and repeat the selecting step for additional ones of the subsections until a full solution is achieved.

It should be noted that an ad hoc method is not necessarily the only way to accommodate fixed resonant links. One or more embodiments of the linear chip build and deterministic approaches can accommodate fixed resonant links.

Generally, method steps disclosed herein can be performed by software on server 901 interacting with LASIQ machines and a database (cloud database 907 is a non-limiting example). Techniques can be implemented by the algorithms disclosed herein or, where specific algorithms are not disclosed, by adapting known techniques as will be apparent to the skilled artisan.

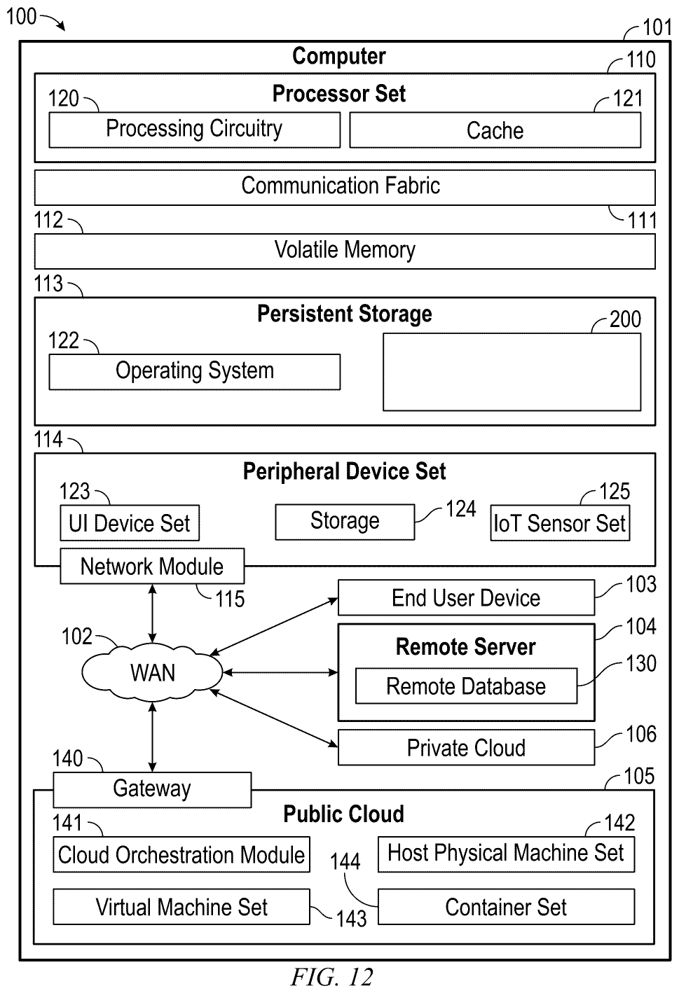

In another aspect (refer, e.g., to discussion of FIG. 12), a computer program product including a computer readable storage medium having program instructions embodied therewith. The program instructions are executable by a processor such as 110 to cause the processor to perform any one, some, or all of the method steps herein; for example, method steps of identifying a plurality of candidate quantum computing chips to be arranged in a multi-chip quantum processor; generating a current optimized tuning plan for the arrangement of the plurality of candidate quantum computing chips in the multi-chip quantum processor; obtaining results of tuning in accordance with the optimized tuning plan from at least one tuning system; carrying out tuning yield assessment based on results of the obtained tuning results; and repeating the steps of obtaining results and carrying out tuning yield assessment, based on tuning being incomplete and the current optimized tuning plan remaining viable.

Optionally, the method performed by the processor further includes, responsive to a subsequent determination that the current optimized tuning plan no longer remains viable, generating a new optimized tuning plan and repeating, for the new optimized tuning plan, the steps of obtaining results and carrying out tuning yield assessment based on tuning being incomplete and the new optimized tuning plan remaining viable.

In another aspect, an exemplary system (e.g., 901, which could be implemented, for example, as per FIG. 12) includes a memory such as 113; and at least one processor such as 110, coupled to the memory, and operative to perform any one, some, or all of the method steps herein; for example, operative to identify a plurality of candidate quantum computing chips to be arranged in a multi-chip quantum processor; generate a current optimized tuning plan for the arrangement of the plurality of candidate quantum computing chips in the multi-chip quantum processor; obtain results of tuning in accordance with the optimized tuning plan from at least one tuning system; carry out tuning yield assessment based on results of the obtained tuning results; and repeat the obtaining of the results and the carrying out of the tuning yield assessment, based on tuning being incomplete and the current optimized tuning plan remaining viable.

In one or more embodiments, the at least one processor is further operative to, responsive to a subsequent determination that the current optimized tuning plan no longer remains viable, generate a new optimized tuning plan and repeat, for the new optimized tuning plan, the obtaining of the results and the carrying out of the tuning yield assessment based on tuning being incomplete and the new optimized tuning plan remaining viable.

In one or more embodiments, the at least one processor is further operative to, responsive to a subsequent determination that tuning is complete, carry out post-tuning analytics.

In a non-limiting example, the results of the tuning include LASIQ (Laser Annealing of Stochastically Impaired Qubits) results.

In one or more embodiments, the memory and at least one processor are associated with a central server computer 901, which obtains tuning results from external LASIQ machines 903-1, 903-2, 903-3, . . . .

Optionally, the system also includes one or more LASIQ (Laser Annealing of Stochastically Impaired Qubits) machines 903-1, 903-2, 903-3, . . . coupled to the central server computer 901.

It will accordingly be appreciated, with reference to FIGS. 5 and 9, that it may be unlikely in a practical scenario to tune all sixteen different chips on the same LASIQ system, so the central server is used to coordinate, and the central server periodically checks whether tuning yield is sufficient to obtain the desired functional yield; if not, generate a new tuning plan. Again, the database is not limited to a cloud database.

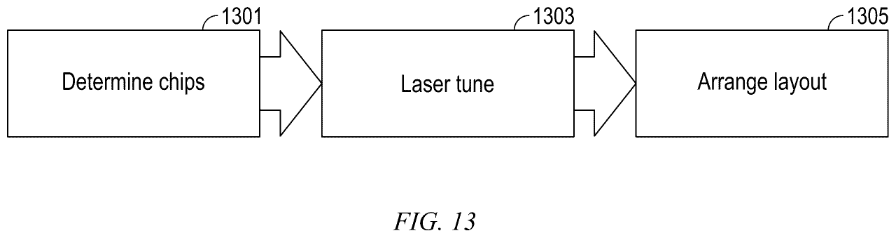

The skilled artisan will appreciate that LASIQ tuning is a physical process, wherein a computer-controlled machine 903-1, 903-2, 903-3, . . . is making physical changes to the Josephson junction. When complete, and the modular devices are located, the end result is a quantum computing device configured and tuned in accordance with techniques disclosed herein, which can be deployed and can carry out quantum calculations. FIG. 13 captures this at a high level, wherein which chips are to be used is determined at 1301, tuning is carried out at 1303, and the layout of the device is arranged at 1305, after which the devices can be deployed and used. Of course, FIG. 13 is a high-level diagram and the other figures should be referred to for exemplary details, iterative loops, etc.

Refer now to FIG. 12, it being understood that techniques disclosed herein include, for example, computer-aided design of a quantum computer, wherein the aspects of the design process can be implemented on any kind of computer, quantum or conventional.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 12.

Computing environment 100 contains an example of an environment for the execution of at least some of the computer code involved in performing the inventive methods, as seen at 200 (e.g., code for frequency control and tuning of modular devices). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 13. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 13 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a plurality of candidate quantum computing chips to be arranged in a multi-chip quantum processor;
generating a current optimized tuning plan for the arrangement of the plurality of candidate quantum computing chips in the multi-chip quantum processor;
obtaining results of tuning in accordance with the optimized tuning plan from at least one tuning system;
carrying out tuning yield assessment based on results of the obtained tuning results; and
repeating the steps of obtaining results and carrying out tuning yield assessment, based on tuning being incomplete and the current optimized tuning plan remaining viable.

2. The method of claim 1, further comprising, responsive to a subsequent determination that the current optimized tuning plan no longer remains viable, generating a new optimized tuning plan and repeating, for the new optimized tuning plan, the steps of obtaining results and carrying out tuning yield assessment based on tuning being incomplete and the new optimized tuning plan remaining viable.

3. The method of claim 1, further comprising, responsive to a subsequent determination that tuning is complete, carrying out post-tuning analytics.

4. The method of claim 1, wherein, in the obtaining step, the results of the tuning comprise LASIQ (Laser Annealing of Stochastically Impaired Qubits) results.

5. The method of claim 4, wherein the results of the tuning are obtained at a central server computer from multiple LASIQ (Laser Annealing of Stochastically Impaired Qubits) machines.

6. The method of claim 1, wherein identifying the plurality of candidate quantum computing chips to be arranged in the multi-chip quantum processor comprises:
accessing a stock of available quantum computing chips;
testing functional and coupling structures of each of said available quantum computing chips;
carrying out laser annealing calibration based on results of said testing;
determining a tuning range of each of the functional and coupling structures;
based on results of said determining of the tuning range and parameters of the stock of available quantum computing chips, determining an acceptable initial resistance range for each of the functional and coupling structures;
based on results of determining an acceptable initial resistance range and junction resistances of the stock of available quantum computing chips, accepting a first fraction of the available quantum computing chips as the plurality of candidate quantum computing chips to be arranged in the multi-chip quantum processor and rejecting a second fraction of the available quantum computing chips.

7. The method of claim 1, wherein generating the current optimized tuning plan for the arrangement of the plurality of candidate quantum computing chips in the multi-chip quantum processor comprises applying a linear chip build approach.

8. The method of claim 7, wherein applying the linear chip build approach comprises:
accessing a stock of available quantum computing chips;
selecting, from the stock, a top ranked chip by estimated functional yield;
finding, from the stock, a best neighbor candidate for the top ranked chip by yield, based on frequency perturbation of the coupling structures; and
repeating the steps of selecting and finding until a full solution is achieved.

9. The method of claim 1, wherein generating the current optimized tuning plan for the arrangement of the plurality of candidate quantum computing chips in the multi-chip quantum processor comprises applying deterministic tuning.

10. The method of claim 9, wherein applying the deterministic tuning comprises:
accessing a specification of potential locations for the plurality of candidate quantum computing chips to be arranged in the multi-chip quantum processor;
defining, based on the specification, frequencies of coupling structures and boundary functional structures for each potential location;
populating, from a stock of acceptable quantum computing chips, the potential locations with ones of the acceptable quantum computing chips capable of tuning to the defined frequencies of coupling structures and boundary functional structures; and
repeating the populating step until a full solution is achieved.

11. The method of claim 1, wherein generating the current optimized tuning plan for the arrangement of the plurality of candidate quantum computing chips in the multi-chip quantum processor comprises applying an ad hoc, subsection-based approach.

12. The method of claim 11, wherein applying the ad hoc, subsection-based approach comprises:
accessing a specification of potential locations for the plurality of candidate quantum computing chips to be arranged in the multi-chip quantum processor, wherein the specification includes fixed resonant links and is partially pre-populated;
defining subsections within the specification, beginning on ones of the subsection corresponding to the partial pre-population;
selecting, from a stock of acceptable quantum computing chips, one or more of the acceptable chips and matching coupling structures in a given one of the subsections until a solution is obtained; and
repeating the selecting step for additional ones of the subsections until a full solution is achieved.

13. A computer program product comprising a computer readable storage medium having program instructions embodied therewith, the program instructions executable by a processor to cause the processor to perform a method comprising:
identifying a plurality of candidate quantum computing chips to be arranged in a multi-chip quantum processor;
generating a current optimized tuning plan for the arrangement of the plurality of candidate quantum computing chips in the multi-chip quantum processor;
obtaining results of tuning in accordance with the optimized tuning plan from at least one tuning system;
carrying out tuning yield assessment based on results of the obtained tuning results; and
repeating the steps of obtaining results and carrying out tuning yield assessment, based on tuning being incomplete and the current optimized tuning plan remaining viable.

14. The computer program product of claim 13, wherein the method performed by the processor further comprises responsive to a subsequent determination that the current optimized tuning plan no longer remains viable, generating a new optimized tuning plan and repeating, for the new optimized tuning plan, the steps of obtaining results and carrying out tuning yield assessment based on tuning being incomplete and the new optimized tuning plan remaining viable.

15. A system comprising:
a memory; and
at least one processor, coupled to said memory, and operative to:
identify a plurality of candidate quantum computing chips to be arranged in a multi-chip quantum processor;
generate a current optimized tuning plan for the arrangement of the plurality of candidate quantum computing chips in the multi-chip quantum processor;
obtain results of tuning in accordance with the optimized tuning plan from at least one tuning system;
carry out tuning yield assessment based on results of the obtained tuning results; and
repeat the obtaining of the results and the carrying out of the tuning yield assessment, based on tuning being incomplete and the current optimized tuning plan remaining viable.

16. The system of claim 15, wherein the at least one processor is further operative to, responsive to a subsequent determination that the current optimized tuning plan no longer remains viable, generate a new optimized tuning plan and repeat, for the new optimized tuning plan, the obtaining of the results and the carrying out of the tuning yield assessment based on tuning being incomplete and the new optimized tuning plan remaining viable.

17. The system of claim 15, wherein the at least one processor is further operative to, responsive to a subsequent determination that tuning is complete, carry out post-tuning analytics.

18. The system of claim 15, wherein the results of the tuning comprise LASIQ (Laser Annealing of Stochastically Impaired Qubits) results.

19. The system of claim 18, wherein the memory and at least one processor are associated with a central server computer.

20. The system of claim 19, further comprising multiple LASIQ (Laser Annealing of Stochastically Impaired Qubits) machines coupled to the central server computer, wherein the tuning results are obtained from the multiple LASIQ (Laser Annealing of Stochastically Impaired Qubits) machines.
